(19) United States
(12) Patent Application Publication
(10) Pub. No.: US 2011/0024332 A1
(43) Pub. Date: Feb. 3, 2011

(54) Recycling method using tagging

(76) Inventor: Yves St-Onge, Mascouche (CA)

Correspondence Address: Franz BONSANG;C/o EQUINOX PROTECTION, 410 - 1500, Du College, St-Laurent, QC, H4L 5G6, CA

(21) Appl. No.: 12/805,417

(22) Filed: Jul. 30, 2010

Related U.S. Application Data
(60) Provisional application No. 61/213,948, filed on Jul. 31, 2009.

(51) Int. Cl. B07C 5/34

(52) U.S. Cl. 209/3.3

(57) ABSTRACT

A method of selectively recycling a specific material involves the use of a DNA taggant detectable in the used material to identify such material for recycling to the originating source of the material to yield focused, selective and cost effective recovery.

### CROSS REFERENCE TO RELATED APPLICATIONS

Benefit of U.S. Provisional Application for Patent Ser. No. 61/213,948, filed on Jul. 31, 2009, which is incorporated herein by reference, is hereby claimed.

### FIELD OF THE INVENTION

The present invention is related to the use of a taggant for identifying a source material in a waste product that is recycled.

### BACKGROUND OF THE INVENTION

It is well known to use taggants for the purpose of identifying products and more specifically in the security field to monitor products to detect counterfeiting or to prevent or assist in preventing theft.

In this connection, US Patent Application Publication No. 2004/0166520 to Connolly proposes the use of DNA inter alia for the purpose set forth above but in a particular manner that allows swift identification in contrast to other systems which require lengthy analysis.

The recycling of spent materials, namely those used particularly in the packaging of foodstuffs and other retail goods, is widespread and in some jurisdictions mandatory in order to reduce the needless wastage of materials such as plastics, metals, etc.

One of the problems associated with recycling is the present inability to provide a qualitative identification regime enabling focused separation and selectivity of the waste products for efficient and cost effective recycling. Some plastics materials are discarded at a relatively high rate simply because the identification of useful elements in the waste products is inadequate thus resulting in a negative saving realization.

For example, there is no such qualitative identification system for consumers and recyclers to ensure the recyclability of #1 PETE, i.e. polyethylene terephthalate.

Accordingly, there is a need for an improved recycling method providing a reliable regime for identifying useful recoverable materials for beneficial and cost effective recycling.

### SUMMARY OF THE INVENTION

It is therefore a general object of the present invention to provide an improved identification system for basic materials thereby enabling their recovery and recylability in a focused or selective manner.

An advantage of the present invention is that specific materials can be provided with a readily detectable taggant thus facilitating the separation thereof from other waste materials, for a more efficient focused green recycling thereof.

Another advantage of the present invention is that the seeding of the material provides an identifiable signature detectable by means of a specially designed detector.

According to a first aspect of the present invention, there is provided a method for selectively recycling a specific material to its originating source, the specific material being seeded with a traceable taggant conferring an identifiable signature on the material for use and disposal thereof by recycling, said method comprising the steps of:
identifying the spent article having the specific material with the traceable taggant for separation thereof and recycling of the specific material.

In one embodiment, the step of identifying the spent article includes the steps of:
subjecting the spent article to a detector step for identifying the signature of the taggant;
separating the so detected article;
returning the article to the originating source; and
recycling the specific material.

According to a second aspect of the present invention, there is provided a method for selectively recycling a specific material to its originating source said method comprising the steps of:
manufacturing an article including the specific material seeded with a traceable taggant for use and disposal thereof;
recycling the spent article; and
identifying the spent article having the specific material with the traceable taggant for separation thereof and recycling of the specific material.

In one embodiment, the step of manufacturing an article includes the steps of:
seeding the specific originating material with a traceable taggant that confers an identifiable signature on the material; and
packaging an article from the specific material for a particular purpose for use and disposal thereof.

Conveniently, the step of identifying the packaging an article includes the steps of:
producing an article from the specific material for a particular purpose;
using the article; and
disposing of the spent article.

The specific material is preferably seeded with traceable DNA, and conveniently the DNA is uniquely applied as at least one marker to the material thus affording ease of identification in the final steps of the recycling method.

The detector employed in the identification stage may be a laser beam and the DNA marker(s) may be so designed as to absorb or reflect the beam thus giving a positive indication of its source identity.

It will be understood that other kinds of detectors may be deployed for the identification of the DNA marker(s).

The specific material may be PETE, but may be any other material capable as a receptor of DNA marking.

Other objects and advantages of the present invention will become apparent from a careful reading of the detailed description provided herein, with appropriate reference to the accompanying drawing.

### BRIEF DESCRIPTION OF THE DRAWING

Further aspects and advantages of the present invention will become better understood with reference to the description in association with the following figure in which:

FIG. 1 is a flow chart showing the various steps of the method according to the invention for recycling a specific material to its originating source from manufacture of the specific material to its selective recycling.

### DETAILED DESCRIPTION OF THE PREFERRED EMBODIMENT

With reference to the annexed drawing the preferred method of the present invention will be herein described for indicative purpose and by no means as of limitation.

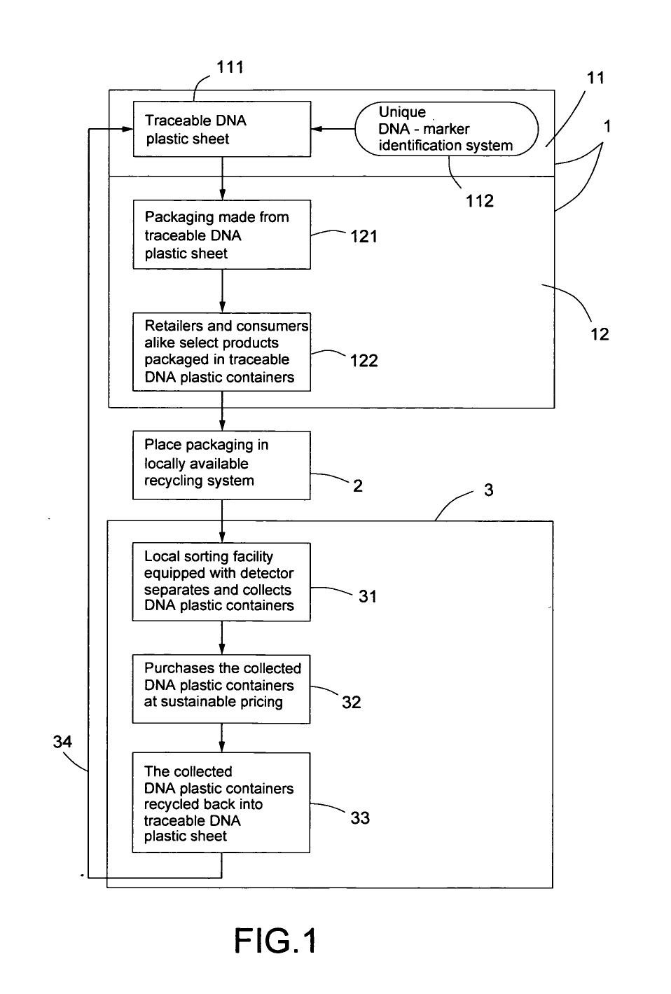

Referring now to the accompanying flow chart in FIG. 1, there is schematically depicted a method for selectively recycling a specific material to its originating source in accordance with the present invention. The method typically includes Step 1 of manufacturing a saleable article including a specific material seeded with a traceable taggant for use and disposal thereof includes a plurality of steps. Step 11 includes Step 111 which entails the manufacture of the specific material, such as #1 PETE or the like, seeded with one or a plurality of traceable DNA markers that confer an identifiable signature on the material, with Step 112 illustrating the unique DNA marker employed. The Step 1 further includes Step 12 of packaging an article from the specific material for a particular purpose for use and disposal thereof as illustrated in Step 121 that shows the PETE material in the form of packaging used in the grocery business, such foods as berries, salad and other vegetables, cakes, etc. and Step 122 which illustrates the use or sale of food products packaged using the PETE material. The method also includes Step 2 which represents the stage following consumption with the packaging discarded for recycling.

Then, the method further includes Step 3 of identifying the spent article having the specific material with the traceable taggant for separation thereof and recycling of the specific material. A recycling facility is depicted at Step 31 with a detector, for a laser beam detector or the like, scanning the waste or spent material for the DNA signature. Waste material displaying the signature as identified by the detector is then returned in Step 32 to the originating source for recycling to produce fresh PETE in Step 33 with Step 34 showing a roll of such fresh PETE with the DNA marking seeded therein, and therefore complete the selective recycling loop cycle.

The present invention provides a selective recycling method that allows for sustainable and cost effective recovery of specific materials, in which only Step 3 above could be considered as an alternative, as long as the material used has a specific taggant therein, or a pre-determined combination thereof, as above-described.

Although the present invention has been described with a certain degree of particularity, it is to be understood that the disclosure has been made by way of example only and that the present invention is not limited to the features of the embodiments described and illustrated herein, but includes all variations and modifications within the scope and spirit of the invention as hereinafter claimed.

I claim:

1. A method for selectively recycling a specific material to its originating source, the specific material being seeded with a traceable taggant conferring an identifiable signature on the material for use and disposal thereof by recycling, said method comprising the steps of:
identifying the spent article having the specific material with the traceable taggant for separation thereof and recycling of the specific material.

2. The method of claim 1, wherein the step of identifying the spent article includes the steps of:
subjecting the spent article to a detector step for identifying the signature of the taggant;
separating the so detected article;
returning the article to the originating source; and
recycling the specific material.

3. The method of claim 1, wherein the traceable taggant is at least one DNA marker.

4. The method of claim 1, wherein the specific material is PETE material.

5. The method of claim 2, wherein the detector step is a laser beam.

6. A method for selectively recycling a specific material to its originating source, said method comprising the steps of:
manufacturing an article including the specific material seeded with a traceable taggant for use and disposal thereof;
recycling the spent article; and
identifying the spent article having the specific material with the traceable taggant for separation thereof and recycling of the specific material.

7. The method of claim 6, wherein the step of manufacturing an article includes the steps of:
seeding the specific originating material with a traceable taggant that confers an identifiable signature on the material; and
packaging an article from the specific material for a particular purpose for use and disposal thereof.

8. The method of claim 7, wherein the step of identifying the spent article includes the steps of:
subjecting the spent article to a detector step for identifying the signature of the taggant;
separating the so detected article;
returning the article to the originating source; and
recycling the specific material.

9. The method of claim 8, wherein the step of identifying the packaging an article includes the steps of:
producing an article from the specific material for a particular purpose;
using the article; and
disposing of the spent article.

10. The method of claim 6, wherein the traceable taggant is at least one DNA marker.

11. The method of claim 6, wherein the specific material is PETE material.

12. The method of claim 8, wherein the detector step is a laser beam.
